(19) United States
(12) Patent Application Publication
(10) Pub. No.: US 2020/0169681 A1
(43) Pub. Date: May 28, 2020

(54) CTIA BASED PIXEL FOR SIMULTANEOUS SYNCHRONOUS FRAME-BASED & ASYNCHRONOUS EVENT-DRIVEN READOUTS

(71) Applicant: BAE Systems Information and Electronic Systems Integration Inc., Nashua, NH (US)

(72) Inventors: James A. Stobie, Duxbury, MA (US); R. Daniel McGrath, Lexington, MA (US)

(21) Appl. No.: 16/199,870

(22) Filed: Nov. 26, 2018

(51) Int. Cl. H04N 5/378; H04N 5/3725; H04N 5/05

(52) U.S. Cl. CPC H04N 5/378; H04N 5/05; H04N 5/3725

(57) ABSTRACT

A hybrid frame-based and event driven pixel, the pixel comprising a frame-based capture circuit, an event-driven capture circuit, and a photodiode in electrical communication with both the frame-based and event-driven capture circuits, wherein the frame-based capture circuit is a capacitive transimpedance amplifier circuit, and wherein the event-driven capture circuit is a linear asynchronous event representation circuit.

### FIELD

The present disclosure relates to pixels, and more particularly, to hybrid capacitive transimpedance amplifier (CTIA) and Linear Asynchronous Event Representation (AER) Time-to-First-Spike (TFS) based pixels for synchronous frame-based & asynchronous event-driven readouts.

### BACKGROUND

Frame-based imagers, which may also be referred to herein as conventional or synchronous operation imagers, are based on the use of a fixed capture interval. In such imagers, a Region of Interest (ROI) on a Focal Plane Array (FPA) or the entire array of pixels is read out at every frame. The readout of frame-based imagers includes both spatial and temporal redundancies, as not all data has changed between frames. This replication of data and readout of more information than necessary results in data bottlenecks for large format high frame rate imagers. Furthermore, reading out the entire array every frame results in high storage and power dissipation requirements, with much of the power being wasted transferring redundant information off of the FPA.

As imaging formats and frame rates continue to rise, power dissipation of imaging components becomes a real concern, especially for man-portable devices, Unmanned Aerial Vehicles (UAVs), and low power surveillance systems, which typically utilize such frame-based imagers.

Asynchronous readouts, which may also be referred to herein as event-driven, are making inroads for machine vision applications by capturing scene dynamics as they appear, allowing for substantially reduced power dissipation and storage requirements. These event-driven readouts accomplish this power savings and minimization of storage requirements by avoiding reading out spatial and temporal redundancies in the scene. These benefits, however, come at the expense of not capturing the scene's detailed contextual contents, which are often necessary for navigation and to identify potential targets of interest within the scene.

While some potential solutions combining event-driven and frame based pixel technology have been offered, these solutions come with disadvantages compared to that of the present disclosure. For instance, one prior art device, which is known as an “Asynchronous Time Based Sensor” or ATIS 100, a schematic of which is provided in FIG. 1, uses a monolithic, silicon-based construction (i.e. photodiodes in the pixel array are silicon-based fabricated in same wafer as Complementary Metal Oxide Semiconductor (CMOS) circuitry), requires two photodiodes, each having their own in-pixel circuitry (one circuit being a Dynamic Vision System (DVS) circuit 102 and the other being a Time-Based Correlated double sampling (CDS) circuit 104), which results in a large unit cell that makes it unsuitable for many applications (the unit cell comprises 77 FETS, 2 capacitors, and 2 photodiodes, which occupy ˜30% of the available unit cell space), and only allows for non-simultaneous readout of event and frame based data. This design is not compatible with small pixels.

Other existing solutions for combining event-driven logarithmic response inputs with frame based imaging that allow simultaneous asynchronous and synchronous operation, including one referred to as a “Dynamic and Active-Pixel Vision Sensor” or DAVIS 200, which combines a DVS circuit 102 with an Active-Pixel Sensor (APS) circuit 202, a schematic of which is provided in FIG. 2, have concentrated on the commercial market for visible imagers, targeting machine vision and driver assistance aids. Like the ATIS 100 shown in FIG. 1, these other commercial offerings are also monolithic, using photo-diodes fabricated in a CMOS substrate, and a visible APS 202 style input for the frame-based readout. Integration capacitance of these designs at the reset drain (V_{dr}) and the floating diffusion node of the Active Pixel Sensor (Vₐₚₛ) 202 are small, based on parasitic elements designed for high sensitivity and limited charge capacities associated with visible imaging. These small capacitances introduce non-linearity into the pixel, degrading thermal imaging performance.

Such designs are not capable of achieving low light sensitivity and are therefore limited to machine vision and driver aid applications. Furthermore, such attempts have resulted in added noise, added dark current and dark noise, added source follower noise, and are not conducive to the proven, low-noise 4T pixel design. Furthermore, such designs do not make efficient use of electrical elements present in their design, using more components than is necessary to operate, thus increasing the size of the circuits, limiting the achievable pixel density and performance thereof.

These faults are, at least in part, a result of the significant differences in the challenges associated with capturing scenes using data having significantly different wavelengths. For instance, when attempting to capture data concerning electromagnetic radiation in the visible, near infrared, or shortwave infrared portion of the spectrum, dark areas are photon starved, making it challenging to detect low photon flux events. Conversely, when attempting to capture data concerning electromagnetic radiation in the thermal infrared portion of the spectrum, the challenge becomes distinguishing a small signal overlaid on top of a large background.

What is needed, therefore, is a pixel with good low-light sensitivity that combines synchronous and asynchronous event-driven readouts, allows for simultaneous synchronous and asynchronous operation, provides a lower-power system approach that is conducive to 4T pixel design, captures detailed scene context, and provides inter-frame scene dynamic updates, at higher effective frame rates than is currently possible, without adding substantial noise to the system while reducing the number of components utilized.

### SUMMARY

The present disclosure provides a system and method for combining synchronous and asynchronous readouts that allows the realization of a relatively low power system that is able to capture detailed scene context while reducing the number of components required and providing inter-frame scene dynamic updates at much higher effective frame rates than is currently possible using purely synchronous techniques. This low-power, dual-modality readout could benefit highly sensitive cooled imaging systems for missile warning and remote sensing applications and expand the capabilities of current dual-mode active and passive imagers, among other applications.

More specifically, a power-efficient approach to combining a traditional frame-based readout with an event-driven readout is proposed. One advantage of this dual-mode pixel is that it enables both readout modalities to operate independently and simultaneously. System power, in embodiments, is reduced by at least on order of magnitude by performing full frame capture at low frame rate and high sensitivity to provide scene context and subsequently coupling this information with an Inertial Measurement Unit (IMU) for synchronizing overall scene motion.

In addition to low power usage, embodiments of the present disclosure also beneficially provide low latency, reduced temporal and spatial redundancies, and do not require a synchronous system clock.

One embodiment of the present disclosure provides a hybrid frame-based and event driven pixel, the pixel comprising: a frame-based capture circuit; an event-driven capture circuit; and a photodiode in electrical communication with both the frame-based and event-driven capture circuits, wherein the frame-based capture circuit is a capacitive transimpedance amplifier circuit, and wherein the event-driven capture circuit is a linear asynchronous event representation circuit.

Another embodiment of the present disclosure provides such a hybrid frame-based and event driven pixel wherein the linear asynchronous event representation circuit is a time-to-first-spike linear asynchronous event representation circuit.

A further embodiment of the present disclosure provides such a hybrid frame-based and event driven pixel wherein the linear, time-to-first-spike, asynchronous event representation portion of the pixel is configured to provide inter-frame auto exposure dependent on photo-current to optimize the signal-to-noise ratio.

Yet another embodiment of the present disclosure provides such a hybrid frame-based and event driven pixel wherein the dynamic range of the linear asynchronous event representation circuit based portion is configured to be set by an input state of the capacitive transimpedance amplifier circuit.

A yet further embodiment of the present disclosure provides such a hybrid frame-based and event driven pixel wherein timing is assigned by an external clock.

Still another embodiment of the present disclosure provides such a hybrid frame-based and event driven pixel wherein the linear asynchronous event representation circuit is configured to encode both an event and a direction of the change.

A still further embodiment of the present disclosure provides such a hybrid frame-based and event driven pixel wherein the pixel design is selected from the group consisting of: a monolithic, silicon-based pixel; a hybrid design, comprising a focal plane array comprising photodiodes that form an array in one substrate material that is bonded to a complementary metal oxide semiconductor readout in another substrate with one or more contacts per pixel to provide electrical contacts; and a stacked design.

Even another embodiment of the present disclosure provides such a hybrid frame-based and event driven pixel wherein the pixel comprises relatively large explicit capacitors configured to provide linear response characteristics.

An even further embodiment of the present disclosure provides such a hybrid frame-based and event driven pixel wherein the photodetector is flip-chip bump bonded to a silicon complementary metal oxide semiconductor readout chip.

A still even another embodiment of the present disclosure provides such a hybrid frame-based and event driven pixel wherein the photodetector is laminated loop-hole bonded to a silicon complementary metal oxide semiconductor readout chip.

A still even further embodiment of the present disclosure provides such a hybrid frame-based and event driven pixel further comprising a pipeline storage element configured to allow for a true integrate-while-readout mode of operation.

Still yet another embodiment of the present disclosure provides such a hybrid frame-based and event driven pixel wherein the photodetector material is selected from the group of materials consisting of InGaAs, InSb, and HgCdTe, and SLS and nBn structured sensors.

A still yet further embodiment of the present disclosure provides such a hybrid frame-based and event driven pixel wherein the photodetector is a quantum-based photodetector.

Even yet another embodiment of the present disclosure provides such a hybrid frame-based and event driven pixel further comprising an inertial measurement unit configured to trigger the frame-based capture circuit upon detection of movement exceeding a predetermined threshold level.

One embodiment of the present disclosure provides a method of obtaining imagery, the method comprising: using a focal plane array comprising a plurality of pixels, each pixel comprising: a frame-based capture circuit; an event-driven capture circuit; and a photodiode in electrical communication with both the frame-based and event-driven capture circuits, wherein the frame-based capture circuit is a capacitive transimpedance amplifier circuit, and wherein the event-driven capture circuit is a linear asynchronous event representation circuit, capturing largely static images using the frame-based capture circuit; and capturing the motion of relatively fast-moving objects using the event-driven capture circuit.

Another embodiment of the present disclosure provides such a method of obtaining imagery wherein the frame-based capture circuit is configured to capture images at a relatively low frame rate and the event-driven capture circuit is configured to capture events at a relatively high frame rate.

A further embodiment of the present disclosure provides such a method of obtaining imagery wherein the capturing of largely static images using the frame-based capture circuit and capturing of the motion of relatively fast-moving objects using the event-driven capture circuit occurs substantially simultaneously.

Yet another embodiment of the present disclosure provides such a method of obtaining imagery further comprising determining a pixel address by accessing a row and column bus structure using a decoding network.

A yet further embodiment of the present disclosure provides such a method of obtaining imagery wherein the focal plane array is configured to perform hierarchical 2D row-first, column-second arbitration.

One embodiment of the present disclosure provides a hybrid frame-based and event driven pixel, the pixel comprising: a frame-based capture circuit; an event-driven capture circuit; an inertial measurement unit configured to trigger the frame-based capture circuit upon detection of movement exceeding a predetermined threshold level; a pipeline storage element configured to allow for a true integrate-while-readout mode of operation; and a photodiode in electrical communication with both the frame-based and event-driven capture circuits, wherein the frame based capture circuit is a capacitive transimpedance amplifier circuit, wherein the event-driven capture circuit is a linear, asynchronous, time-to-first spike event representation circuit, wherein the linear, time-to-first-spike, asynchronous event representation portion of the pixel is configured to provide inter-frame auto exposure dependent on photo-current to optimize the signal-to-noise ratio, wherein the dynamic range of the linear asynchronous event representation circuit based portion is configured to be set by an input state of the capacitive transimpedance amplifier circuit, wherein the linear asynchronous event representation circuit is configured to encode both an event and a direction of the change, and wherein timing is assigned by an external clock.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a schematic showing a prior art Asynchronous Time Based Sensor (ATIS);

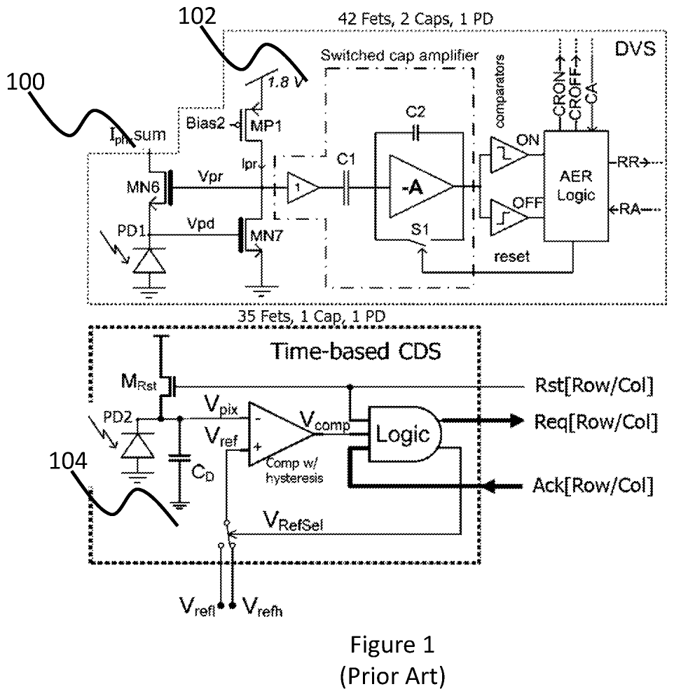

FIG. 2 is a schematic showing a prior art Dynamic and Active-Pixel Vision Sensor (DAVIS);

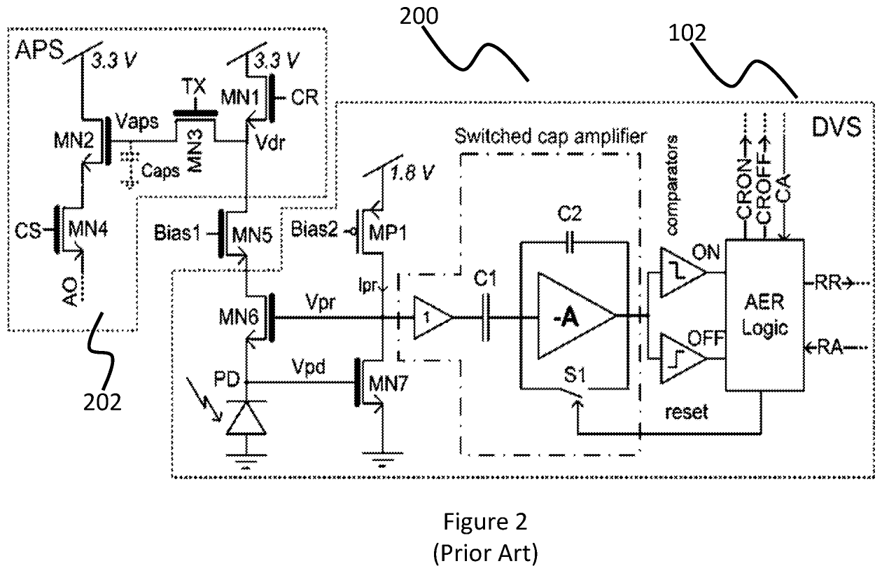

FIG. 3 is a graph describing the behavior of a classical, frame-based pixel;

FIG. 4 is a graph showing the behavior of an event-driven pixel;

FIG. 5 is flowchart illustrating the high-level design of a pixel in accordance with embodiments of the present disclosure; and

FIG. 6 is a schematic showing an embodiment of a pixel in accordance with the present disclosure.

### DETAILED DESCRIPTION

As a preliminary matter, three configurations for solid-state imagers are discussed herein. The first, which is described herein as monolithic, silicon-based construction, refers to a Focal Plane Array (FPA) where photodiodes in the pixel array are silicon-based and fabricated in the same wafer as CMOS circuitry. A second configuration, which is herein referred to as a hybrid design, describes an FPA where photodiodes form an array in a non-silicon semiconductor material that is bonded to a CMOS readout with one or more contacts per pixel to provide electrical contacts. The final design is herein referred to as a stacked configuration and describes an FPA having photodiodes fabricated in a silicon-based substrate that can be integrated with simple MOS circuitry and then bonded to a readout circuit fabricated in a separate substrate.

As described in the background section, conventional imagers are based on the use of a fixed capture interval, and are herein referred to as “Frame based” or synchronous imagers 300. In such imagers, a Region of Interest (ROI) or the entire array of pixels, the FPA, is read out at every frame.

The readout of such conventional, frame-based imagers 300 includes both spatial and temporal redundancies, as not all data has changed between frames. This replication of data and readout of more information than is necessary can result in data bottlenecks for large format high frame rate imagers. Furthermore, reading out the entire array every frame results in high power dissipation requirements, much of which is wasted transferring redundant information off of the FPA, and also results in large storage requirements.

Frame-based imagers 300, however, do offer some significant benefits over event-driven imagers 400. For instance, frame-based imagers 300 offer full two dimensional coverage of the scene with high sensitivity from low to high intensity detector signals, down to the read noise level, albeit at the expense of high power and large storage requirements, as discussed above. Unlike event driven imagers 400, there is no minimum threshold level which must be traversed before a pixel measurement is made.

The temporal sensitivity of frame-based imagers 300 is directly proportional to the frame rate and exposure time. The dynamic range of such imagers is limited to the signal capacity of the input cell, which is typically <60 dB for single gain mode, but this can be higher if digital FPAs are used. The dynamic range of frame-based imagers 300 can also be extended using gain compression response or dual-gain architecture.

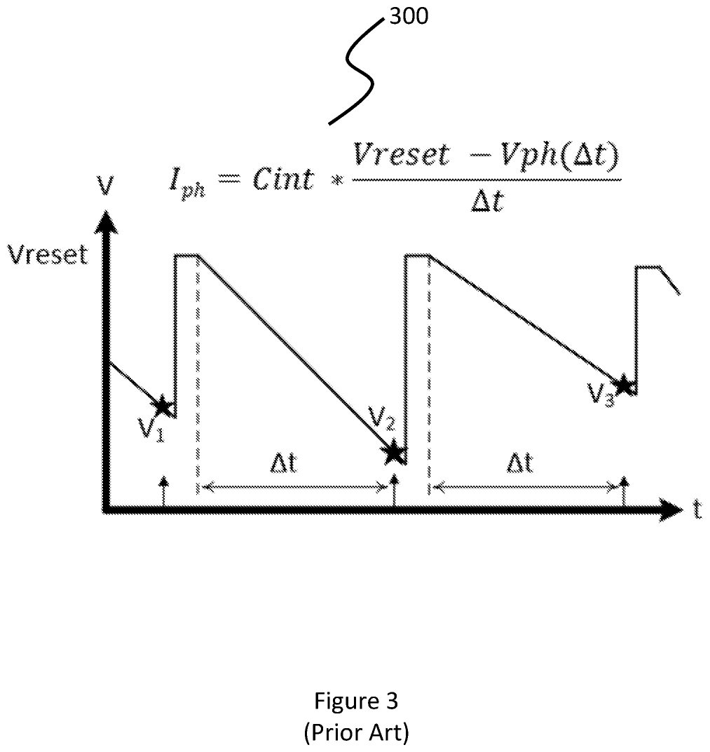

FIG. 3 describes the function of a classical, frame-based imager 300 graphically. More specifically, frame based imagers 300 measure voltage on a given pixel over a known, fixed time interval, the integration period. Frame-based imagers 300 than quantize the voltage received during the fixed time interval, using it to generate a reproducible image. Notable features of frame-based imagers 300 that can be seen in FIG. 3 include full frame capture at fixed time intervals, including redundant spatial & temporal pixels and continuous clocking of all pixels.

In contrast to classical, frame-based imagers 300, event-driven or asynchronous imagers 400 only send out information, which may include pixel address, a time stamp, and measured intensity, when a discernable event occurs, e.g. when a threshold is exceeded. More specifically, event-driven readouts 400 are designed to output pixel information when a temporal change is sensed. This design: eliminates both spatial and temporal redundancies; reducing data throughput bandwidth while providing lossless data compression, by collecting only unique temporal scene information. This significantly reduces power requirements in the imager and in the FPA signal processing chain.

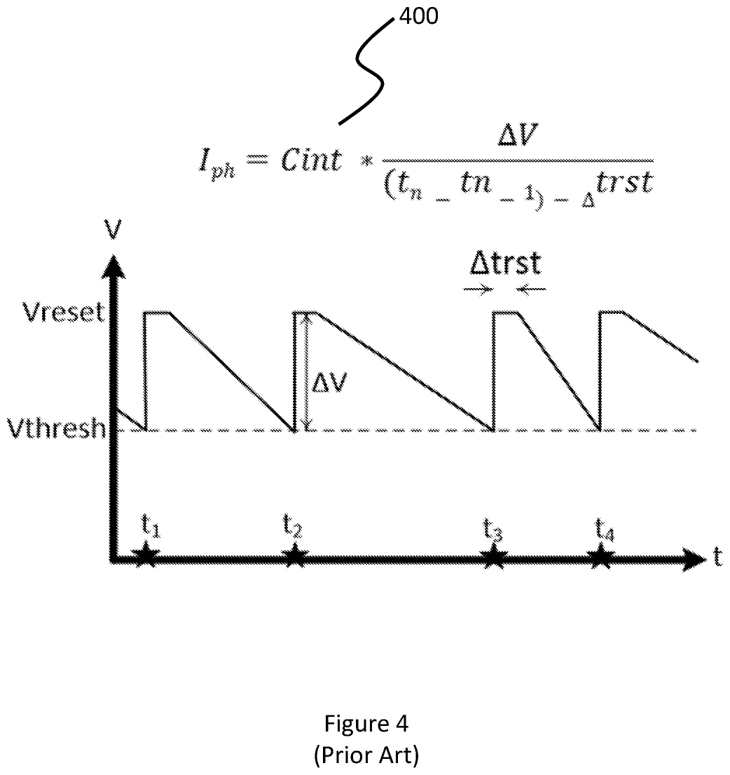

Event-driven imagers 400 operate by measuring the time duration required for the sensor signal to change by a preset amount, effectively quantizing time, as graphically-described in FIG. 4. Such imagers are typically based on pulse modulation, which is used to convert intensity change to time. Events are determined when a pre-determined threshold is exceeded, either positive or negative; this is a measure of the temporal contrast. Each pixel event is conveyed to the output with the event arrival time and the pixel location, both row and column indices, and is referred to as an Asynchronous Event Readout (AER). Directional contrast changes can also be conveyed through the AER using an additional event bit. More than 6-orders of magnitude (>120 dB) dynamic range is possible with such imagers and minimum contrast thresholds as low as 1.5% have been demonstrated.

Furthermore, event-driven imagers 400 only read individual pixels that incur an event, typically using AER, in serial or parallel readout, dependent on design requirements. Because pixels reach the threshold voltage at varying times, readout is asynchronous, immediate, and pixel-specific, as opposed to the FPA-wide readout of a classical, frame-based, synchronous imager 300, conserving bandwidth and power and/or allowing for higher effective framerates, which can be 100's of KHz with response times as short as 3 μs.

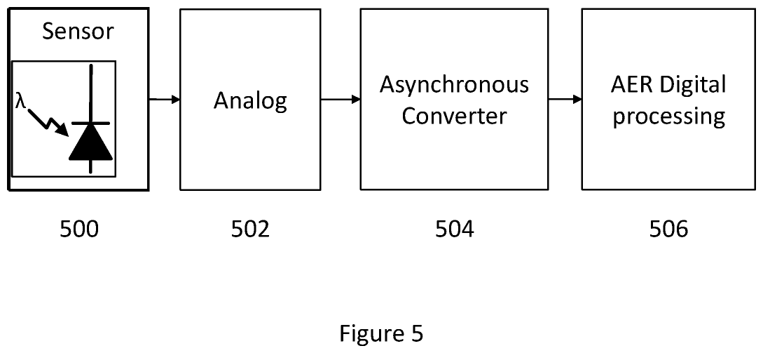

FIG. 5 provides a flowchart illustrating the high-level design of an asynchronous, event-driven input unit cell (i.e. pixel cell), in accordance with embodiments of the present disclosure. In other words, the figure describes time-domain photo-transduction, in accordance with embodiments of the present disclosure. The sensor 500, in embodiments, may be a quantum-based detector (e.g. photodiode) with a fast response time. In embodiments, the detector 500 is made from silicon, InGaAs, InSb, HgCdTe, Strain Layer Superlatices (SLS) and semiconductor-barrier-semiconductor (nBn) structured sensors, and/or nanoparticles. The sensor 500 output is then transferred to an analog module 502, which may measure individual photon response, linear response (e.g. 3T APS), or logarithmic response and which may be further configured to amplify sensor 500 output and/or perform correlated double sampling thereon. The output of the analog module 500 is then transferred to an asynchronous converter module 504 which, in embodiments, performs differentiation and/or threshold comparison. Finally, the output from the asynchronous converter module 504, in embodiments, is provided to an AER digital processing module 506 that, in embodiments, determines the direction of signal change, allowing for temporal differencing, conveys the pixel address to another module, and/or performs AER readout handshaking, including sending row and column event requests, receiving row and column acknowledgements, and resetting pixels following acknowledgements.

Event-driven pixels 400 have a number of benefits, including lower power and bandwidth requirements, compared to classical, frame-based pixels 300, although they trade intensity (i.e. contrast) and sensitivity (i.e. threshold level) to gain these benefits. In addition, such pixels allow for a relatively large dynamic range, which can be extended using gain compression. Event-driven pixels 400 also allow Gamma correction through monotonic variation of the threshold level.

Event-driven sensors 400 primarily consist of three types: those that react to a change in the linear pixel response, those that measure a single photon incident on a pixel, and those that react to a logarithmic response. Logarithmic response pixels provide moderate background noise and a large dynamic range. Such event-driven imagers 400 typically utilize a subthreshold Field Effect Transistor (FET) to maintain detector bias in a feedback loop comprising a high gain inverting amplifier configured to maintain a fixed photo-diode bias voltage. The gate to source voltage of this FET varies proportionally to the natural logarithm of the current generated by the detector, including photo-generated and dark currents. During use, a small change in detector current introduces a voltage change that is amplified and fed back to the gate of the FET, which quickly adjusts to provide the FET current necessary maintain a fixed detector bias. A predetermined change in this gate voltage then triggers the pixel readout event, which outputs the pixel 2-D address and time of event.

Single photon response event-driven imagers 400 provide low background noise and moderate dynamic range. These sensors are used, among other things, for photon counting, in such devices as single-photon avalanche diodes (SPADs, AKA Geiger mode APDs), which are solid-state photodetectors in which a photon-generated carrier (via the internal photoelectric effect) can trigger a short-duration, but relatively large, avalanche current. Essentially, each photon registers as an event and its pixel address is sent off-chip. Photon events are then counted off-chip. Such a technique is ideal for low light applications and between 20 and 100 million events/second are possible using such techniques. Unfortunately, dark shot noise, which is a result of dark leakage current in the image sensor, is also registered as an event and must be taken into account, which can limit sensitivity.

Lastly, linear response event-driven imagers 400 provide moderate background noise and dynamic range and function by measuring the time to a first crossing. In such event-driven imagers, detector current is integrated onto a capacitor, and when the integrated voltage exceeds a pre-determined threshold an event is triggered and the capacitor is reset. This design behaves like a one-bit Analog-to-Digital Converter (ADC) or sigma delta converter in each cell. Each event is immediately transmitted off-chip along with the pixel address.

Two sub-types of linear response asynchronous, event-driven pixels 400, both of which use pulse modulation techniques are: Time to first spike (TFS) after last reset (Pulse width Modulation); and Spiking Pixel case, Frequency of spikes (Frequency Modulation, FM), which can lead to event crowding.

In all event-driven imagers 400, the threshold voltage value is inversely correlated to acquisition speed and pixel resolution. Choosing a threshold voltage value relatively close to the reset voltage provides a relatively short integration time, which increases the event rates and power dissipation, but decreases the picture resolution by obscuring other pixels during a “handshake” time, during which information is being transferred. Furthermore, in event-driven imagers 400 highly illuminated areas present fast update rates and high dynamic range, while lower light areas suffer from motion artifacts and limited dynamic range.

While event-driven imagers 400 are ideal for highlighting changes in a scene over time, such as target tracking, or navigating busy streets, detailed scene texture information is generally lost due to the resolution threshold limitations of such sensors.

By augmenting classical, frame-based imagers 300 with asynchronous, event-driven readout 400 using threshold sensing, as described herein, the benefits of event-driven imager 400 design can be obtained without incurring the disadvantages of such technology.

More specifically, embodiments combine event-driven logarithmic sensing with conventional, frame-based imaging 300. In embodiments conventional imaging 300 is used for scene content analysis while event-driven imaging 400 is used to measure temporal contrast events for target tracking, fast inter-frame update rates, and/or guide ROIs for readout. These embodiments offer reduced power usage with lower frame capture rates and low latency for changes in scene.

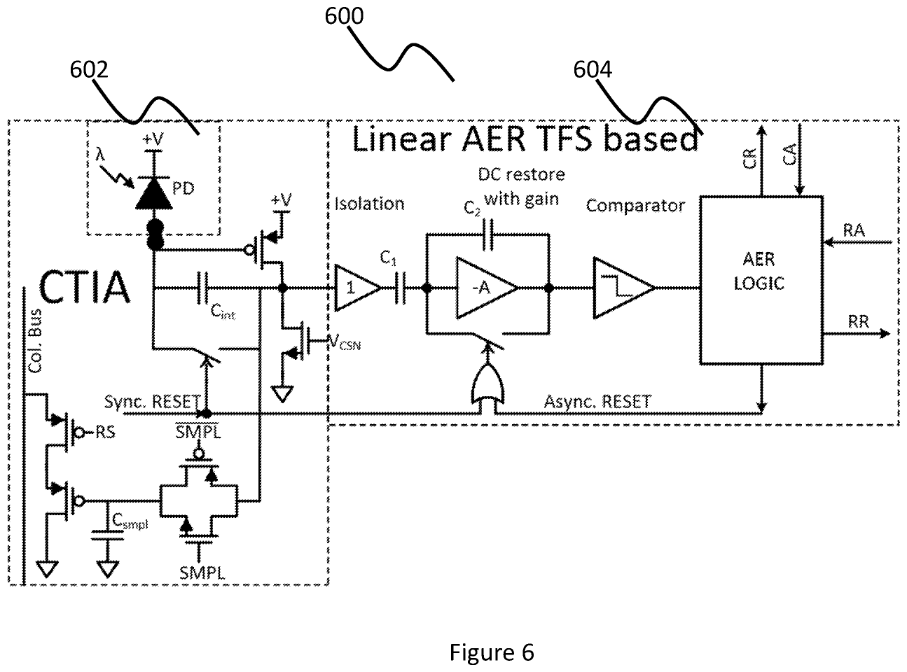

Now referring to FIG. 6, a hybrid capacitive transimpedance amplifier (CTIA) 602 and Linear AER Time-to-First-Spike (TFS) 604 based pixel 600 in accordance with embodiments of the present disclosure is shown, schematically. In the pixel of FIG. 6 600, the Linear AER TFS based portion 604 produces a differential linear response to thresholding events. In embodiments, the dynamic range of the Linear AER TFS based portion 604 is set by the CTIA 602 input state. In embodiments, the Linear AER TFS based portion 604 must be reset synchronous with the CTIA 602 input when operated simultaneously, in addition to asynchronous resets. Lastly, embodiments of the Linear AER TFS based portion 604 of the pixel 600 provide inter-frame auto exposure dependent on photo-current to optimize the signal-to-noise ratio.

Now regarding asynchronous event-driven readout periphery circuits, AERs, in embodiments, convey event occurrence and pixel address information. In embodiments, linear response pixels using TFS encode the magnitude of the pixel current. For temporal differencing pixel embodiments, both the event and direction of the change is encoded. In embodiments, timing is assigned by an external clock upon the receipt of an event request.

In embodiments, a pixel address is determined through accessing a row and column bus structure using a decoding network.

Regarding asynchronous event channel capacity, at high event rates the probability of event collision occurring on a bus increase, at which point timing data can be lost or misinterpreted. For example, unfettered channel access only allows the use of 18% of total channel capacity before a collision occurs, on average, once for every ten events. In embodiments, contention occurs if two or more events attempt to transmit simultaneously with random access to the shared communication channel, allowing corrupted transmissions to be detected and discarded. Unfettered access has a short cycle time, but collisions increase rapidly as the load increases.

In embodiments, when one or more rows request are received, almost simultaneously, a process referred to as arbitration is used to decide how to handle the information. A similar arbitration process is needed for the column pixels in each row. This operation is performed around the periphery of the pixel array.

Arbitration means the pixel events are queued and wait their turn for access to the shared bus. Embodiments utilize several forms of arbitration, including: Non-greedy—ensures that a row or column that is serviced by the arbiter is guaranteed not to be services again before all other rows and columns that have registered requests have been serviced; Greedy—If both inputs in an arbiter sub-cell are selected at the same time arbitration will service both before moving on to others (this local prioritization saves cycle time); and Fair—alternate priority, a toggle switch selects input A or input B first depending on its setting for a 2-input arbiter sub-cell (the toggle switch, in embodiments, is changed with acknowledge signals from higher arbiter stages).

In embodiments, hierarchical 2-D Row-First Column-Second Arbitration is used to save time by servicing all active event-triggered pixels in a chosen row before another row is picked.

In embodiments, handshaking is done to minimize pixel crowding on buses. One way of accomplishing this is through row dominate addressing (Row First Column Second), i.e. a pixel with an event first sends a request on the row line and then waits for acknowledgement, then each of the pixels in the row send out request on their bus lines. When column acknowledgement is received, the pixel is reset. Minimizing the handshake interval through pipelining is implemented in embodiments to minimize bus crowding.

In embodiments, the detector array substrate is flip-chip bump bonded while, in other embodiments, it is laminated loop-hole (DRS) to a silicon CMOS readout chip.

In embodiments, the detector can be configured to cover from UV to VLWIR bands.

In embodiments, the pixel includes a pipeline storage element, allowing for true integrate-while-readout mode of operation.

Additionally, a hybrid detector scheme used in embodiments opens up the spectral band to include not only silicon based visible/NIR, but also InGaAs, InSb, and HgCdTe, and SLS and nBn structured sensor for use in the infrared reflective and thermal bands.

In embodiments, changes within the scene are captured by the event-driven readouts 400, which provide inter-frame scene dynamics at an effective frame rate, which, in embodiments, is several orders of magnitude faster than current state of the art frame-based systems 300, while also saving considerable power.

In embodiments, quantum-based detectors, which can respond on the order of micro-seconds or less, are used to respond rapidly to intensity changes.

The foregoing description of the embodiments of the disclosure has been presented for the purposes of illustration and description. It is not intended to be exhaustive or to limit the disclosure to the precise form disclosed. Many modifications and variations are possible in light of this disclosure. It is intended that the scope of the disclosure be limited not by this detailed description, but rather by the claims appended hereto.

What is claimed is:

1. A hybrid frame-based and event driven pixel, the pixel comprising:
a frame-based capture circuit;
an event-driven capture circuit; and
a photodiode in electrical communication with both the frame-based and event-driven capture circuits,
wherein said frame-based capture circuit is a capacitive transimpedance amplifier circuit, and
wherein said event-driven capture circuit is a linear asynchronous to event representation circuit.

2. The pixel of claim 1 wherein said linear asynchronous event representation circuit is a time-to-first-spike linear asynchronous event representation circuit.

3. The pixel of claim 2 wherein the linear, time-to-first-spike, asynchronous event representation portion of the pixel is configured to provide inter-frame auto exposure dependent on photo-current to optimize the signal-to-noise ratio.

4. The pixel of claim 1 wherein the dynamic range of the linear asynchronous event representation circuit based portion is configured to be set by an input state of the capacitive transimpedance amplifier circuit.

5. The pixel of claim 1 wherein timing is assigned by an external clock.

6. The pixel of claim 1 wherein said linear asynchronous event representation circuit is configured to encode both an event and a direction of the change.

7. The pixel of claim 1 wherein said pixel design is selected from the group consisting of: a monolithic, silicon-based pixel; a hybrid design, comprising a focal plane array comprising photodiodes that form an array in one substrate material that is bonded to a complementary metal oxide semiconductor readout in another substrate with one or more contacts per pixel to provide electrical contacts; and a stacked design.

8. The pixel of claim 1 wherein said pixel comprises relatively large explicit capacitors configured to provide linear response characteristics.

9. The pixel of claim 1 wherein said photodetector is flip-chip bump bonded to a silicon complementary metal oxide semiconductor readout chip.

10. The pixel of claim 1 wherein said photodetector is laminated loop-hole bonded to a silicon complementary metal oxide semiconductor readout chip.

11. The pixel of claim 1 further comprising a pipeline storage element configured to allow for a true integrate-while-readout mode of operation.

12. The pixel of claim 1 wherein said photodetector material is selected from the group of materials consisting of InGaAs, InSb, and HgCdTe, and SLS and nBn structured sensors.

13. The pixel of claim 1 wherein said photodetector is a quantum-based photodetector.

14. The pixel of claim 1 further comprising an inertial measurement unit configured to trigger the frame-based capture circuit upon detection of movement exceeding a predetermined threshold level.

15. A method of obtaining imagery, the method comprising:
using a focal plane array comprising a plurality of pixels, each pixel comprising:
a frame-based capture circuit;
an event-driven capture circuit; and
a photodiode in electrical communication with both the frame-based and event-driven capture circuits,
wherein said frame-based capture circuit is a capacitive transimpedance amplifier circuit, and
wherein said event-driven capture circuit is a linear asynchronous event representation circuit,
capturing largely static images using the frame-based capture circuit; and
capturing the motion of relatively fast-moving objects using the event-driven capture circuit.

16. The method of claim 15 wherein said frame-based capture circuit is configured to capture images at a relatively low frame rate and said event-driven capture circuit is configured to capture events at a relatively high frame rate.

17. The method of claim 15 wherein the capturing of largely static images using the frame-based capture circuit and capturing of the motion of relatively fast-moving objects using the event-driven capture circuit occurs substantially simultaneously.

18. The method of claim 15 further comprising determining a pixel address by accessing a row and column bus structure using a decoding network.

19. The method of claim 15 wherein said focal plane array is configured to perform hierarchical 2D row-first, column-second arbitration.

20. A hybrid frame-based and event driven pixel, the pixel comprising:
a frame-based capture circuit;
an event-driven capture circuit;
an inertial measurement unit configured to trigger the frame-based capture circuit upon detection of movement exceeding a predetermined threshold level;
a pipeline storage element configured to allow for a true integrate-while-readout mode of operation; and
a photodiode in electrical communication with both the frame-based and event-driven capture circuits,
wherein said frame based capture circuit is a capacitive transimpedance amplifier circuit,
wherein said event-driven capture circuit is a linear, asynchronous, time-to-first spike event representation circuit,
wherein the linear, time-to-first-spike, asynchronous event representation portion of the pixel is configured to provide inter-frame auto exposure dependent on photo-current to optimize the signal-to-noise ratio,
wherein the dynamic range of the linear asynchronous event representation circuit based portion is configured to be set by an input state of the capacitive transimpedance amplifier circuit,
wherein said linear asynchronous event representation circuit is configured to encode both an event and a direction of the change, and
wherein timing is assigned by an external clock.
